(19) United States
(12) Patent Application Publication
(10) Pub. No.: US 2014/0349035 A1
(43) Pub. Date: Nov. 27, 2014

(54) METHOD OF MANUFACTURING DECORATION ELEMENT AND DECORATION ELEMENT

(71) Applicant: Hwajin Co., Ltd., Gyeongsangbuk-do (KR)

(72) Inventors: Manho Cho, Gyeonggi-do (KR); Jaeyoel Lee, Daegu (KR); Dongmin Kim, Gyeongsangbuk-do (KR)

(21) Appl. No.: 13/924,166

(22) Filed: Jun. 21, 2013

(30) Foreign Application Priority Data
May 21, 2013 (KR) 10-2013-0057308

(51) Int. Cl. B44F 5/00; B60R 13/02; B60R 13/04; B44C 1/22

(52) U.S. Cl. CPC B44F 5/00; B44C 1/227; B60R 13/02; B60R 13/04
USPC 428/31; 216/32; 428/201; 428/203

(57) ABSTRACT

A method of manufacturing a decoration element is provided. The method includes: forming a base layer; forming a metal layer having a preset thickness on an upper surface of the base layer; forming a mask layer including punched patterns having preset shapes on an upper surface of the metal layer; and etching the metal layer on which the mask layer is formed, to form etched patterns on the metal layer having the same shapes as the punched patterns.

### PRIORITY

This application claims the priority under 35 U.S.C. §119 to Korean Patent Application No. 10-2013-0057308, filed on May 21, 2013, in the Korean Intellectual Property Office, the disclosure of which is incorporated herein in its entirety by reference.

### BACKGROUND OF THE INVENTION

1. Field of the Invention

The present invention relates to a method of manufacturing a decoration element and a decoration element, and more particularly, to a method of manufacturing a decoration element, by which an etched pattern having the same shape as a punched pattern of a mask layer is rapidly formed in large quantities in a metal layer, and a decoration element having a high decoration sense due to a combination of colors and shapes of a base layer, a mask layer, and a metal layer.

2. Description of the Related Art

A panel type decoration element in which a metal layer such as chrome is plated on a base layer formed of a polymer resin is mainly used as an internal element of an interior decoration of a car or an external element for an exterior decoration of the car.

As to a method of manufacturing a decoration element, Korean Patent Publication No. 10-2012-0025156, applied on Sep. 7, 2010, discloses a method of processing an external surface of a mold, including: forming a metal layer on an external surface of an injection mold; forming a photoresist layer on the metal layer; arranging a photomask on the photoresist layer and irradiating light onto the photomask; and performing etching to remove a remaining part of the metal layer and the photoresist layer except for a part corresponding to a pattern formed in the photomask.

Since the above-described method includes irradiating ultraviolet light onto the photoresist layer, the method may be applied if the external surface of the injection mold is flat or an area of the external surface of the injection mold is relatively narrow. Also, since the method includes removing the entire portion of the photoresist layer, a process may be complicated and total process cost may increase.

### SUMMARY OF THE INVENTION

The present invention provides a method of manufacturing a decoration element, by which an etched pattern having the same shape as a punched pattern of a mask layer is rapidly formed in large quantities in a metal layer.

The present invention also provides a decoration element having a high decoration sense due to a combination of colors and shapes of a base layer, a mask layer, and a metal layer.

According to an aspect of the present invention, there is provided a method of manufacturing a decoration element. The method may include: forming a base layer; forming a metal layer having a preset thickness on an upper surface of the base layer; forming a mask layer including punched patterns having preset shapes on an upper surface of the metal layer; and etching the metal layer on which the mask layer is formed, to form etched patterns having the same shapes as the punched patterns in the metal layer.

The metal layer may be formed on the upper surface of the base layer by using a vapor deposition method.

The metal layer may include at least one selected from the group consisting of aluminum (Al), stainless steel, tin (Sn), indium (In), magnesium (Mg), copper (Cu), nickel (Ni), titanium (Ti), chrome (Cr), silver (Ag), and iron (Fe).

The mask layer may be formed by using a pad printing method that uses an elastic pad. The mask layer may be formed in a transparent or translucent state so that at least a portion of the metal layer is observed from the outside. The mask layer may include color dyes having a preset color.

Before forming the metal layer, the method may further include: forming a primer layer having a preset thickness on an upper surface of the base layer. The primer layer may be formed in a transparent or translucent state so that at least a portion of the base layer is observed from the outside.

After etching the metal layer, the method may further include: removing impurities remaining on surfaces of the metal layer and the mask layer by using a cleaning solution. After removing the impurities, the method may further include: removing water remaining on the surfaces of the meta layer and the mask layer to dry the surfaces of the metal layer and the mask layer.

After etching the metal layer, the method may further include: forming a protection layer to protect the metal layer and the mask layer. The protection layer may be formed in a transparent or translucent state so that at least portions of the metal layer and the mask layer are observed from the outside.

According to another aspect of the present invention, there is provided a decoration element including: a base layer; a metal layer which is arranged so that a surface thereof faces a surface of the base layer and is formed to a preset thickness on a surface of the base layer; and a mask layer which is arranged so that a surface thereof faces an other surface of the metal layer to be attached on the other surface of the metal layer and comprises punched patterns having preset shapes, wherein the metal layer has etched patterns having the same shapes as the punched patterns of the mask layer.

The metal layer may include at least one selected from the group consisting of Al, stainless steel, Sn, In, Mg, Cu, Ni, Ti, Cr, Ag, and Fe. The mask layer may be formed in a transparent or translucent state so that at least a portion of the metal layer is observed from the outside. The mask layer may include color dyes having a preset color.

The decoration element may further include: a primer layer which is disposed between the metal layer and the base layer and is formed to a preset thickness on a surface of the base layer. The primer layer may be formed in a transparent or translucent state so that at least a portion of the base layer is observed. The decoration element may further include: a protection layer which is formed to cover the metal layer and the mask layer. The protection layer may be formed in a transparent or translucent state so that at least portions of the metal layer and the mask layer are observed from the outside. The decoration element may be used as an internal element for an interior decoration of a car or an external element for an exterior decoration of the car.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of manufacturing a decoration element according to an exemplary embodiment of the present invention;

FIG. 2 is a cross-sectional view illustrating a decoration element in which a primer layer is formed on a base layer, according to an exemplary embodiment of the present invention;

FIG. 3 is a cross-sectional view illustrating the decoration element of FIG. 2 in which a metal layer is formed on the primer layer;

FIG. 4 is a cross-sectional view illustrating the decoration element of FIG. 3 in which a mask layer is formed on the metal layer;

FIG. 5 is a cross-sectional view illustrating the metal layer of the decoration element of FIG. 4 that is etched;

FIG. 6 is a cross-sectional view illustrating the decoration element of FIG. 5 in which a protection layer is formed on the etched metal layer; and

FIG. 7 is a cross-sectional view illustrating a base layer and a metal layer of a decoration layer on which light is irradiated and then reflected, according to an exemplary embodiment of the present invention.

### DETAILED DESCRIPTION OF PREFERRED EMBODIMENTS

Exemplary embodiments of the present invention will now be described in detail with reference to the attached drawings.

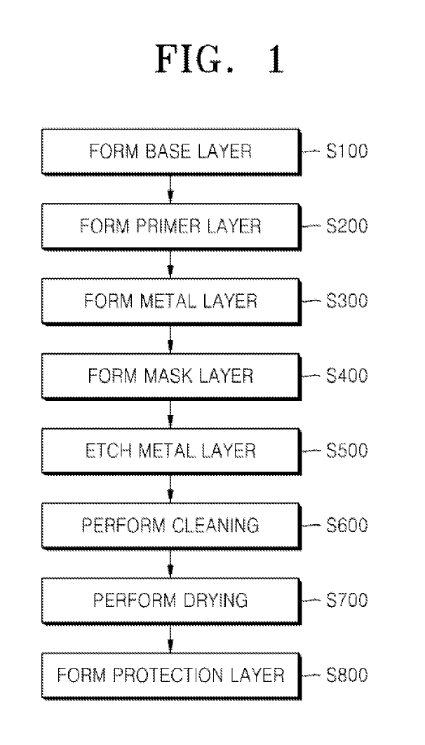

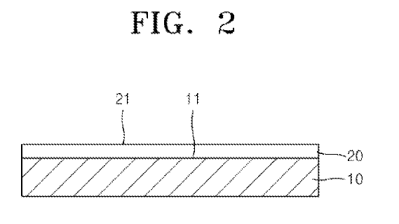

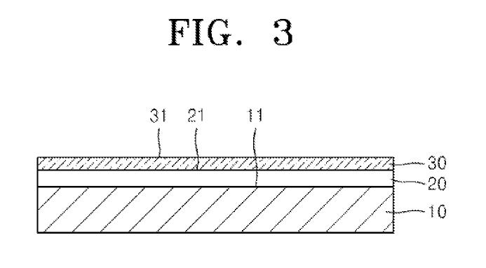

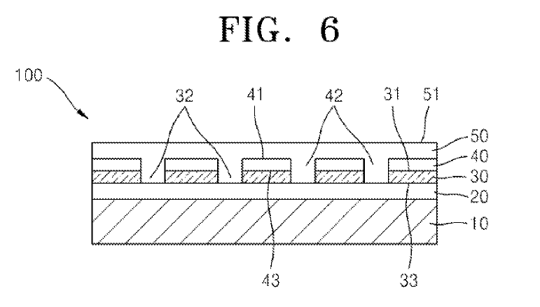

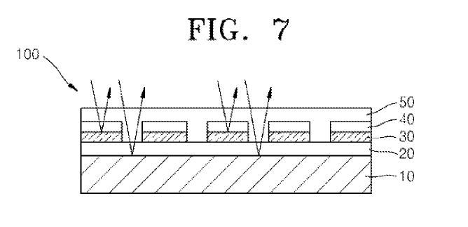

FIG. 1 is a flowchart illustrating a method of manufacturing a decoration element 100 (shown in FIGS. 6 and 7) according to an exemplary embodiment of the present invention. FIG. 2 is a cross-sectional view illustrating a decoration element in which a primer layer 20 is formed on a base layer 10, according to an exemplary embodiment of the present invention. FIG. 3 is a cross-sectional view illustrating the decoration element of FIG. 2 in which a metal layer 30 is formed on the primer layer 20.

Referring to FIGS. 1 through 3, the method refers to a method of manufacturing the decoration element 100 that is used as an internal element for an interior decoration of a car or an external element for an exterior decoration of the car and includes operations S100 through S500. The base layer 10 is formed in operation S100, the primer layer 20 is formed in operation S200, the metal layer 30 is formed in operation S300, a masker layer 40 is formed in operation S400, and the metal layer 30 is etched in operation S500.

Operation S100 refers to an operation of forming the base layer 10 that is a base of the decoration element 100. The base layer 10 may be formed by using at least one synthetic resin selected from the group consisting of polycarbonate (PC), polyurethane (PU), polypropylene (PP), polyethylene terephthalate (PET), polymethyl methacrylate (PMMA), acrylonitrile butadiene styrene (ABS) resin, polyvinyl chloride (PVC), polybutylene terephthalate (PBT), polyethylene (PE), polyamide (PA), and polycarbonate/acrylonitrile butadiene styrene (PC/ABS) composite resin.

In the present exemplary embodiment, the base layer 10 is manufactured as a panel type element including an upper surface 11 that is formed as a curved surface having a preset or predetermined curvature by using the PC/ABS composite resin (Operation S100).

In operation S200, as shown in FIG. 2, the primer layer 20 having a preset or predetermined thickness is formed on the upper surface 11 of the base layer 10 formed in operation S100. Alkyd resin coating, chlorinated rubber resin varnish, vinyl resin varnish, epoxy resin coating, polyurethane resin varnish, acrylic resin varnish, or the like is coated on the upper surface 11 of the base layer 10 to form the primer layer 20.

Here, the above-mentioned varnishes that are raw materials of the primer layer 20 may be classified into two-component varnishes having hardeners and one-component varnishes having no hardeners according to whether hardeners are contained. Alternatively, the varnishes may be classified into heat hardening varnishes that perform hardening by using heat and light hardening varnishes that irradiate ultraviolet rays (UVs) and perform drying, according to varnish hardening methods.

In the present exemplary embodiment, polyurethane resin varnish is coated on the upper surface 11 of the base layer 10 and then hardened by using heat to form the primer layer 20. In other embodiments, light hardening varnishes are available as the primer layer 20.

Here, as shown in FIG. 7, the primer layer 20 is formed in a transparent state or a translucent state so that at least a portion of the base layer 10 is visually observed from the outside (Operation S200).

In operation S300, as shown in FIG. 3, the metal layer 30 having a preset or predetermined thickness is formed on an upper surface 21 of the primer layer 20. The metal layer 30 is formed of a metal including at least one selected from the group consisting of aluminum (Al), stainless steel, tin (Sn), indium (In), magnesium (Mg), copper (Cu), nickel (Ni), titanium (Ti), chrome (Cr), silver (Ag), and iron (Fe).

In the present exemplary embodiment, the metal layer 30 is formed on the upper surface 21 of the primer layer 20 by using a vapor deposition method. Various vapor deposition methods are well known to those of ordinary skill in the art, and a detailed description thereof is omitted as the vapor deposition methods available in the relevant art can be used.

In this embodiment, the metal layer 30 may be formed to a thickness between 5 nm and 1,000 nm. In other embodiments, the metal layer 30 may be formed to a thickness between 5 nm and 500 nm (Operation S300).

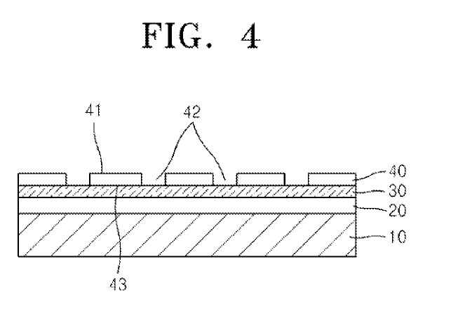

In operation S400, as shown in FIG. 4, the mask layer 40 including punched patterns 42 having predetermined shapes is formed on an upper surface 31 of the metal layer 30. The mask layer 40 may be formed by using a natural resin such as at least one synthetic resin or nitrocellulose selected from the group consisting of PA and polyester.

The punched patterns 42 may be abstract unit patterns that are irregularly arranged or unit patterns that are repeatedly arranged and may provide a decoration effect. As shown in FIG. 4, shapes of the punched patterns 42 are determined by a holed flat shape that penetrate an upper surface 41 of the mask layer 40 into a lower surface 43 of the mask layer 40.

In the present exemplary embodiment, mask liquid varnish including polyester is coated on the upper surface 310 of the metal layer 30 and then hardened by using heat to form the mask layer 40.

In the present exemplary embodiment, the mask layer 40 is printed by using a pad printing method that uses an elastic pad formed of a material having elasticity such as rubber, silicon rubber, glue, or the like.

The pad printing method refers to a method of directly printing an elastic pad on a product. In other words, the mask liquid varnish contained in a copperplate printing having the same flat shape as the punched patterns 42 is coated on the elastic pad and then transferred onto the metal layer 40 that is a body to be printed. Differently from a screen printing method by which only flat screen printing is possible, precise curved surface printing may be performed on a surface having a flat surface, a curved surface, a concave surface, or a convex surface and a small area in the pad printing method.

In the present exemplary embodiment, the mask layer 40 is formed in a transparent state or a translucent form so that at least a portion of the metal layer 30 is visually observed from the outside (Operation S400).

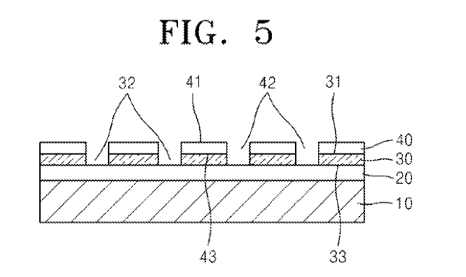

In operation S500, as shown in FIG. 5, the metal layer 30 on which the mask layer 40 is formed is etched to form etched patterns 32 having the same shapes as the punched patterns 42 in the metal layer 30.

As shown in FIG. 5, shapes of the etched patterns 32 are determined by holed flat shapes that penetrate the upper surface 31 of the metal layer 30 to a lower surface 33. The etched patterns 32 have the same flat shapes as the punched patterns 42.

The etching refers to a processing method that uses a chemical corrosive action and is classified into wet etching and dry etching.

The wet etching refers to etching that uses a liquid chemical having a property of rusting and dissolving only target metal. The wet etching has the following shortcomings. A large number of substrates are processed at a time, and equipment or a chemical is expensive. Also, as an etching depth is deep, rusting of a section direction proceeds, and thus micromachining having high precise is difficult. In addition, an etching speed varies according to a temperature of the chemical.

The dry etching refers an etching process that uses a reaction through gaseous plasma not chemicals used for the wet etching. The dry etching remedies the shortcomings of the wet etching and thus is advantageous to precise micromachining.

In the present exemplary embodiment, the wet etching is used, and at least one solution selected from the group consisting of NaOH, FeCl3, aqua regia, nitric acid, and hydrochloric acid may be used etchant. In the present exemplary embodiment, NaOH is used as the etchant. Here, the etchant does not rust the primer layer 20 and the mask layer 40 but rusts only the metal layer 30 (Operation S500).

After operation S500 is performed, operation S600 is performed. In other words, in operation S600, impurities remaining on surfaces of the primer layer 20, the metal layer 30, and the mask layer 40 are first removed by using an alkaline cleaning solution and then subsequently removed by using pure water that does not include impurities.

After operation S600 is performed, in operation S700, water remaining on the surfaces of the primer layer 20, the metal layer 30, and the mask layer 40 are removed and then dried.

After operation S700 is performed, in operation S800, a protection layer 50 is formed to protect the primer layer 20, the metal layer 30, and the mask layer 40, thereby completely manufacturing the decoration element 100.

The protection layer 50 is coated on the upper surface 41 of the mask layer 40 and is filled into holes forming the etched patterns 32 and the punched patterns 42 to be coated on the upper surface 21 of the primer layer 20. In the present exemplary embodiment, the protection layer 50 is coated so that an upper surface 51 thereof is flat.

Here, Alkyd resin coating, chlorinated rubber resin varnish, vinyl resin varnish, epoxy resin coating, polyurethane resin varnish, acrylic resin varnish, or the like is coated on the upper surface 41 of the mask layer 40 to form the protection layer 50.

In the present exemplary embodiment, the protection layer 50 is formed of polyurethane resin varnish in a transparent or translucent state so that the base layer 10, the metal layer 30, and at least a portion of the mask layer 40 are observed from the outside as shown in FIG. 7 (Operation S800).

According to the method of manufacturing the decoration element 100, as shown in FIG. 6, the decoration element 100 is manufactured as follows. The base layer 10, the primer layer 20 formed on the upper surface 11 of the base layer 10, and the lower surface 33 face the upper surface 21 of the primer layer 20. Also, the metal layer 30 is formed on the upper surface 21 of the primer layer 20 to a predetermined thickness and the lower surface 43 face and is attached onto the upper surface 31 of the metal layer 30. The mask layer 40 includes the punched patterns 42 having the preset shapes, and the protection layer 50 is coated on the upper surface 41 of the mask layer 40. The metal layer 30 has the etched patterns 32 having the same flat shapes as the punched patterns 42 of the mask layer 40.

The method includes operations S300 of forming the metal layer 30 having the preset or predetermined thickness on the upper surface 11 of the base layer 10, S400 of forming the mask layer 40 including the punched patterns 42 having the preset shapes on the upper surface 31 of the metal layer 30, and S500 of etching the metal layer 30 to form the etched patterns 32 having the same shapes as the punched patterns 42 on the metal layer 30. Therefore, the etched patterns 32 having the same shapes as the punched patterns 42 of the mask layer 40 may be rapidly in large quantities on the metal layer 30. Also, since colors and shapes of the base layer 10, the mask layer 40, and the metal layer 30 are mingled with one another, a decoration appeal of the decoration element 100 may substantially increase.

Also, according to the above-described method, in operation S300, the metal layer 30 is formed on the upper layer 11 of the base layer 10 by using the vapor deposition method. Therefore, mass production is possible, an adhesive strength between the base layer 10 and the metal layer 30 is high, and the metal layer 30 is formed in a thin film form.

In operation S400 of the method, the mask layer 40 is printed by using the pad printing method that uses the elastic pad. Therefore, different from the screen printing method by which flat screen printing is possible, even if the upper surface 31 of the metal layer 30 is a complicated surface including a curved surface, a surface having a relatively small area, a concave surface, a convex surface, or the like, precise printing of the mask layer 40 is possible.

In operation S400 of the method, the mask layer 40 is formed in the transparent or translucent state, and thus at least a portion of the metal layer 30 is observed from the outside. Therefore, a color or a texture and a pattern of the metal layer 30 may be transmitted to a user through the mask layer 40.

Before operation S300, the method further includes operation S200 of forming the primer layer 20 having the preset thickness on the upper surface 11 of the base layer 10. Even if the base layer 10 is not smooth due to low smoothness of the upper surface 11 of the base layer 10, smoothness of the upper surface 21 of the primer layer 20 may be increased. Therefore, the metal layer 30 may be formed to be smooth.

In operation S200 of the method, the primer layer 20 is formed in the transparent or translucent state. Therefore, since at least a portion of the base layer 10 is observed, a color or a texture and a pattern of the base layer 10 may be transmitted to the user through the primer layer 20.

After operation S500, the method further includes operation S600 of removing the impurities remaining on the surfaces of the metal layer 20 and the mask layer 40 by using the cleaning solution. Therefore, an adhesive strength between the protection layer and the mask layer 40 may be increased, and impurities may be prevented from being contained in the protection layer 50.

After operation S600 is performed, the method includes operation S700 of removing the water remaining on the surfaces of the metal layer 30 and the mask layer 40 to dry the surfaces of the metal layer 30 and the mask layer 40. Therefore, an adhesive strength between the protection layer 50 and the mask layer 40 is prevented from being lowered.

After operation S500 is performed, the method further includes operation S800 of forming the protection layer 50 to protect the metal layer 30 and the mask layer 40. Therefore, the metal layer 30 and the mask layer 40 may be prevented from being damaged by an external shock, and a decoration effect may occur due to the protection layer 50.

In operation S800 of the method, the protection layer 50 is formed in the transparent or translucent. Therefore, at least portions of the metal layer 30 and the mask layer 40 may be observed from the outside, and thus colors or textures and patterns of the base layer 10, the metal layer 30, and the mask layer 40 may be transmitted to the user through the protection layer 50.

In the present exemplary embodiment, the base layer 10 is formed of a synthetic resin that is a PC/ABS composite resin but may be formed of a material such a metallic board, a non-metallic board, a lumber board, or the like.

In the present exemplary embodiment, the metal layer 30 is formed by using the vapor deposition method but may be formed by using one of various methods such as a plating method, a painting method, etc.

The mask layer 40 is formed in the transparent or translucent state in the present exemplary embodiment but may be formed to include color dyes having a preset or predetermined color. Here, a color of the metal layer 30 and a color of the mask layer 40 are mixed with each other to increase a decoration sense and appeal.

The mask layer 40 is printed by using the pad printing method in the present exemplary embodiment but may be formed by using a UV thermosetting method or a silk screen printing method if the upper surface 11 of the base layer 10 is flat.

As described above, according to the present invention, a method of manufacturing a decoration element is provided. The method includes: forming a metal layer having a preset thickness on an upper surface of a base layer; forming a mask layer including punched patterns having preset shapes on an upper surface of the metal layer; and etching the metal layer on which the mask layer is formed, to form etched patterns having the same shapes as the punched patterns on the metal layer. Therefore, the etched patterns having the same shapes as the punched patterns of the mask layer may be rapidly formed in large quantities on the metal layer. Also, colors and shapes of the base layer, the mask layer, and the metal layer may be combined with one another to provide the decoration element having a high decoration sense.

While the present invention has been particularly shown and described with reference to exemplary embodiments thereof, it will be understood by those of ordinary skill in the art that various changes in form and details may be made therein without departing from the spirit and scope of the present invention as defined by the following claims.

We claim:

1. A method of manufacturing a decoration element, the method comprising:
forming a base layer;
forming a metal layer having a predetermined thickness on an upper surface of the base layer;
forming a mask layer comprising punched patterns having predetermined shapes on an upper surface of the metal layer; and
etching the metal layer to form etched patterns having the same shapes as the punched patterns in the metal layer.

2. The method of claim 1, wherein the step of forming the metal layer comprises forming the metal layer on the upper surface of the base layer by using a vapor deposition method.

3. The method of claim 1, wherein the step of forming the metal layer comprises forming the metal layer with at least one selected from the group consisting of aluminum (Al), stainless steel, tin (Sn), indium (In), magnesium (Mg), copper (Cu), nickel (Ni), titanium (Ti), chrome (Cr), silver (Ag), and iron (Fe).

4. The method of claim 1, wherein the step of forming the mask layer comprises forming the mask layer using a pad printing method that uses an elastic pad.

5. The method of claim 1, wherein the step of forming the mask layer comprises forming the mask layer in a transparent or translucent state so that at least a portion of the metal layer is observed from the outside.

6. The method of claim 1, wherein the mask layer comprises color dyes having a predetermined color.

7. The method of claim 1, further comprising:
prior to forming the metal layer, forming a primer layer having a predetermined thickness on an upper surface of the base layer.

8. The method of claim 7, wherein the step of forming the primer layer comprises forming the primer layer in a transparent or translucent state so that at least a portion of the base layer is observed from the outside.

9. The method of claim 1, further comprising:
subsequent to etching the metal layer, removing impurities remaining on surfaces of the metal layer and the mask layer by using a cleaning solution.

10. The method of claim 9, further comprising:
subsequent to removing the impurities, removing water remaining on the surfaces of the meta layer and the mask layer to dry the surfaces of the metal layer and the mask layer.

11. The method of claim 1, further comprising:
subsequent to etching the metal layer, forming a protection layer to protect the metal layer and the mask layer.

12. The method of claim 11, wherein the step of forming the protection layer comprises forming the protection layer in a transparent or translucent state so that at least portions of the metal layer and the mask layer are observed from the outside.

13. A decoration element comprising:
a base layer;
a metal layer which is arranged so that a surface thereof faces a surface of the base layer and is formed to a predetermined thickness on a surface of the base layer; and
a mask layer which is arranged so that a surface thereof faces an other surface of the metal layer to be attached on the other surface of the metal layer and comprises punched patterns having predetermined shapes;
wherein the metal layer has etched patterns having the same shapes as the punched patterns of the mask layer.

14. The decoration element of claim 13, wherein the metal layer comprises at least one selected from the group consisting of Al, stainless steel, Sn, In, Mg, Cu, Ni, Ti, Cr, Ag, and Fe.

15. The decoration element of claim 13, wherein the mask layer is formed in a transparent or translucent state so that at least a portion of the metal layer is observed from the outside.

16. The decoration element of claim 13, wherein the mask layer comprises color dyes having a preset color.

17. The decoration element of claim 13, further comprising:
a primer layer which is disposed between the metal layer and the base layer and is formed to a predetermined thickness on a surface of the base layer.

18. The decoration element of claim 17, wherein the primer layer is formed in a transparent or translucent state so that at least a portion of the base layer is observed.

19. The decoration element of claim 13, further comprising:
a protection layer which is formed to cover the metal layer and the mask layer.

20. The decoration element of claim 19, wherein the protection layer is formed in a transparent or translucent state so that at least portions of the metal layer and the mask layer are observed from the outside.

21. A car comprising the decoration element of claim 13, wherein the decoration element is used as an internal element for an interior decoration of the car or an external element for an exterior decoration of the car.
